(19) United States
(12) Patent Application Publication
(10) Pub. No.: US 2026/0269136 A1
(43) Pub. Date: Sep. 10, 2026

(54) MULTI-UNIT MULTILAYER CERAMIC CAPACITOR

(71) Applicant: Murata Manufacturing Co., Ltd., Nagaokakyo-shi (JP)

(72) Inventor: Kazunori USUI, Nagaokakyo-shi (JP)

(21) Appl. No.: 19/657,245

(22) Filed: Apr. 24, 2026

Related U.S. Application Data
(63) Continuation of application No. PCT/JP2025/007999, filed on Mar. 5, 2025.

(51) Int. Cl. H01G 4/30; H01G 4/012; H01G 4/242; H01G 4/38

(52) U.S. Cl. CPC H01G 4/30; H01G 4/012; H01G 4/242; H01G 4/385

(57) ABSTRACT

A multi-unit multilayer ceramic capacitor includes a multilayer body including dielectric layers and inner electrode layers, and first and second outer electrodes. The multilayer body includes, inside a single element assembly, capacitors each including dielectric layers and inner electrode layers. The capacitors are positioned at predetermined intervals in length and lamination directions. The inner electrode layers include first inner electrode layers connected to the first outer electrode, and second inner electrode layers connected to the second outer electrode. Each of the first inner electrode layers includes a first counter electrode portion, and a first extended portion protruding toward the first outer electrode. Each of the second inner electrode layers includes a second counter electrode portion, and a second extended portion protruding toward the second outer electrode.

### CROSS REFERENCE TO RELATED APPLICATIONS

This application is a Continuation Application of PCT Application No. PCT/JP2025/007999 filed on Mar. 5, 2025. The entire contents of this application are hereby incorporated herein by reference.

### BACKGROUND OF THE INVENTION

### 1. Field of the Invention

The present invention relates to multi-unit multilayer ceramic capacitors.

### 2. Description of the Related Art

Along with improvement in performance of APUs (Accelerated Processing Units) to be used for smartphones, etc., impedance design has been more difficult to secure power supply stability during high-speed operation. Most common measures are to prepare a plurality of general two-terminal capacitors in which inner electrode layers are exposed on both end surfaces, appropriately select the two-terminal capacitors depending on different frequency characteristics, and dispose the two-terminal capacitors in parallel on power supply lines, thereby reducing impedance over a wide band.

### SUMMARY OF THE INVENTION

However, there is concern that this method has problems of an increase in costs and a decrease in yields due to an increase in number of mounted components.

Therefore, example embodiments of the present invention provide multi-unit multilayer ceramic capacitors in each of which reduction in costs and improvement in yields are achieved and production efficiency can be improved.

A multilayer ceramic capacitor according to an example embodiment of the present invention is a multi-unit multilayer ceramic capacitor including a multilayer body including a first side surface and a second side surface that face each other in a lamination direction, a first principal surface and a second principal surface that face each other in a height direction orthogonal to the lamination direction, and a first end surface and a second end surface that face each other in a length direction orthogonal to both the lamination direction and the height direction, a first outer electrode extending in the lamination direction on the second principal surface, and a second outer electrode extending in the lamination direction on the second principal surface. The multilayer body includes, inside a single element assembly, a plurality of capacitors each including a plurality of dielectric layers and a plurality of inner electrode layers. The plurality of capacitors are positioned at predetermined intervals in the length direction and the lamination direction. The inner electrode layers include first inner electrode layers connected to the first outer electrode, and second inner electrode layers connected to the second outer electrode. Each of the first inner electrode layers includes a first counter electrode portion, and a first extended portion protruding toward the first outer electrode. Each of the second inner electrode layers includes a second counter electrode portion, and a second extended portion protruding toward the second outer electrode.

In a multilayer ceramic capacitor according to an example embodiment of the present invention, the multilayer body includes, inside the single element assembly, the plurality of capacitors each including the plurality of dielectric layers and the plurality of inner electrode layers. The plurality of capacitors are positioned at the predetermined intervals in the length direction and the lamination direction. The inner electrode layers include the first inner electrode layers connected to the first outer electrode, and the second inner electrode layers connected to the second outer electrode. Each of the first inner electrode layers includes the first counter electrode portion, and the first extended portion protruding toward the first outer electrode. Each of the second inner electrode layers includes the second counter electrode portion, and the second extended portion protruding toward the second outer electrode. Thus, the current path can be shortened, and therefore ESL (Equivalent Series Inductance) can be reduced compared with a general two-terminal capacitor in which inner electrode layers are exposed on both end surfaces. In addition, the plurality of two-terminal capacitors can be replaced only with the multi-unit multilayer ceramic capacitor. Further, the number of capacitors inside the multilayer body of the multi-unit multilayer ceramic capacitor is adjusted depending on disposition of land electrodes. Therefore, the disposition of the land electrodes for the general two-terminal capacitors can be used as it is without changing design.

According to example embodiments of the present invention, it is possible to provide multi-unit multilayer ceramic capacitors in each of which reduction in costs and improvement in yields are achieved and production efficiency can be improved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating a multi-unit multilayer ceramic capacitor according to an example embodiment of the present invention.

FIG. 2 is a bottom view illustrating an example of a multi-unit multilayer ceramic capacitor according to an example embodiment of the present invention.

FIG. 3 is a left-hand side view illustrating an example of a multi-unit multilayer ceramic capacitor according to an example embodiment of the present invention.

FIG. 4 is a schematic cross-sectional view taken along line IV-IV in FIG. 1.

FIG. 5 is a schematic cross-sectional view taken along line V-V in FIG. 1.

FIG. 6 is a schematic cross-sectional view taken along line VI-VI in FIG. 3.

FIG. 7 is a schematic cross-sectional view taken along line VII-VII in FIG. 3.

FIG. 8 is a see-through perspective view illustrating disposition of inner electrode layers inside a multilayer body of a multi-unit multilayer ceramic capacitor according to an example embodiment of the present invention.

FIG. 9 is a see-through perspective view illustrating disposition of extended portions of the inner electrode layers inside a multilayer body of a multi-unit multilayer ceramic capacitor according to an example embodiment of the present invention.

FIG. 10 is an exploded perspective view of a multilayer body of a multi-unit multilayer ceramic capacitor according to an example embodiment of the present invention.

FIG. 11 is a bottom view illustrating a modification of outer electrodes of a multi-unit multilayer ceramic capacitor according to an example embodiment of the present invention.

FIG. 12 is a bottom view illustrating another modification of outer electrodes of a multi-unit multilayer ceramic capacitor according to an example embodiment of the present invention.

### DETAILED DESCRIPTION OF THE EXAMPLE EMBODIMENTS

Next, examples of multi-unit multilayer ceramic capacitors according to example embodiments of the present invention are described.

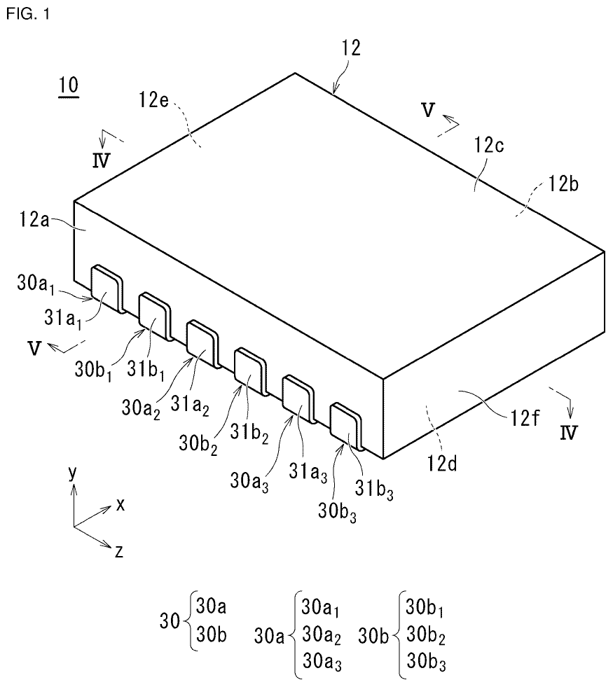

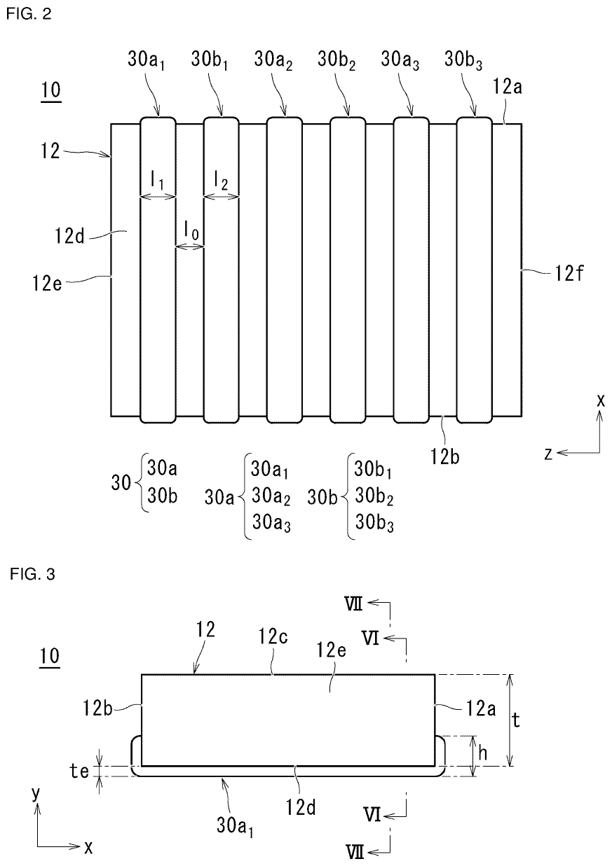

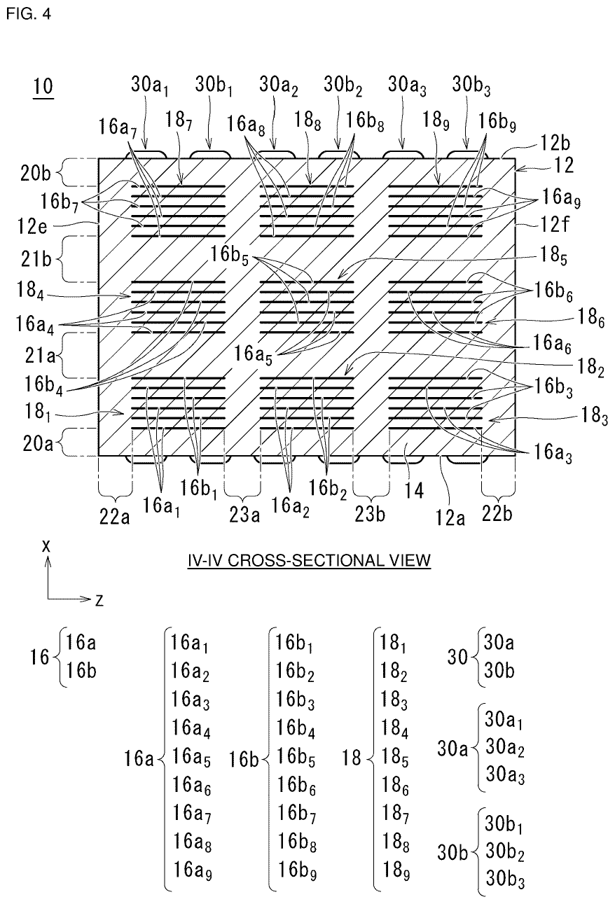

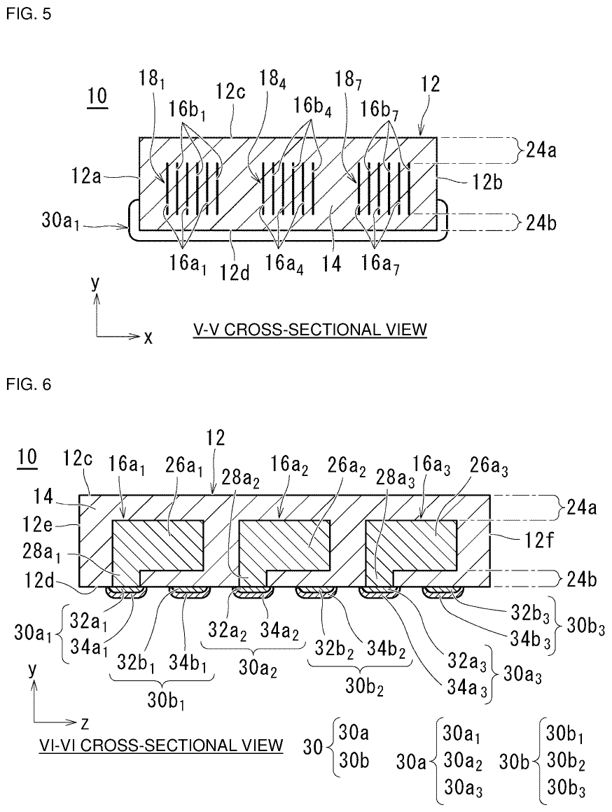

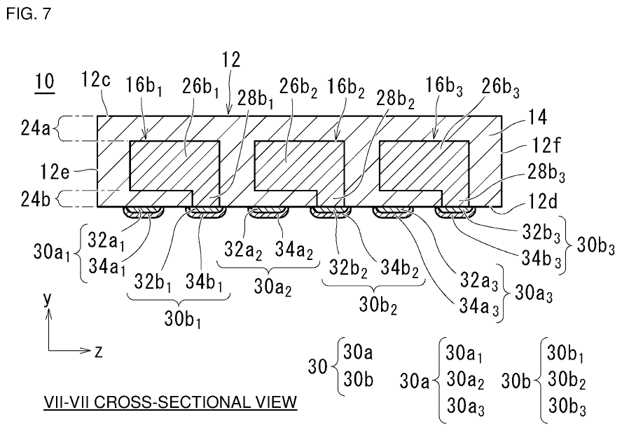

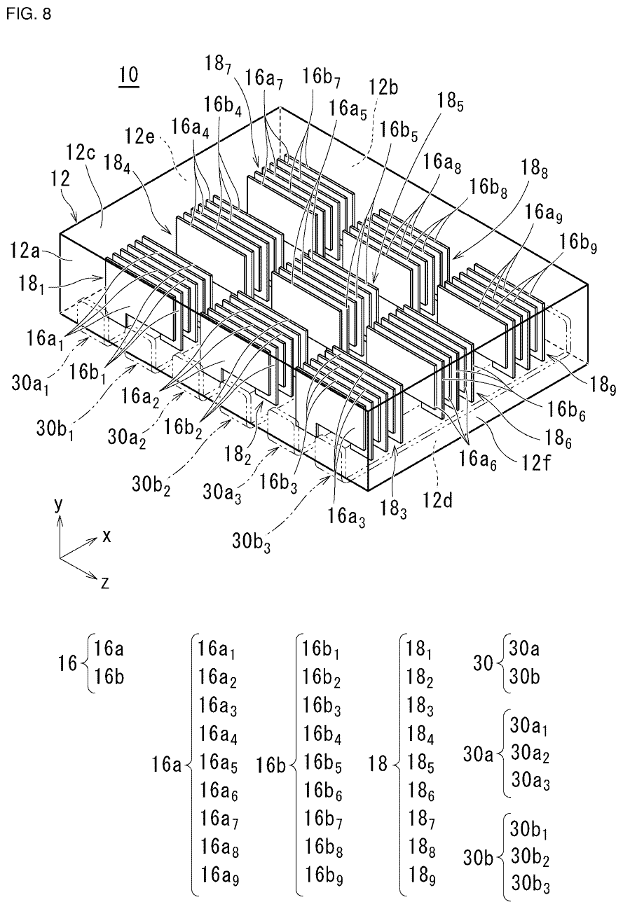

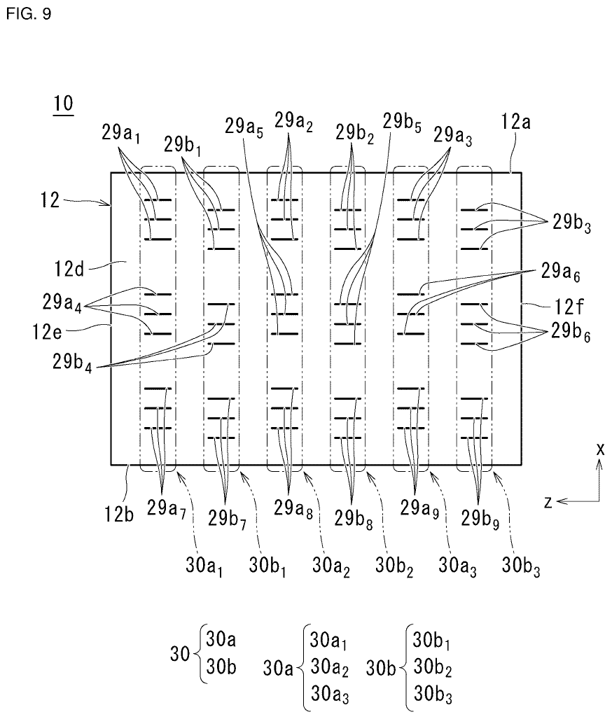

FIG. 1 is an external perspective view illustrating a multi-unit multilayer ceramic capacitor according to a present example embodiment of the present invention. FIG. 2 is a bottom view illustrating an example of the multi-unit multilayer ceramic capacitor according to the present example embodiment of the present invention. FIG. 3 is a left-hand side view illustrating an example of the multi-unit multilayer ceramic capacitor according to the present example embodiment of the present invention. FIG. 4 is a schematic cross-sectional view taken along line IV-IV in FIG. 1. FIG. 5 is a schematic cross-sectional view taken along line V-V in FIG. 1. FIG. 6 is a schematic cross-sectional view taken along line VI-VI in FIG. 3. FIG. 7 is a schematic cross-sectional view taken along line VII-VII in FIG. 3. FIG. 8 is a see-through perspective view illustrating disposition of inner electrode layers inside a multilayer body of a multi-unit multilayer ceramic capacitor according to an example embodiment of the present invention. FIG. 9 is a see-through perspective view illustrating disposition of extended portions of the inner electrode layers inside a multilayer body of a multi-unit multilayer ceramic capacitor according to an example embodiment of the present invention.

As illustrated in FIG. 1 and FIG. 2, the multi-unit multilayer ceramic capacitor 10 includes, for example, a multilayer body 12 and outer electrodes 30.

The multilayer body 12 includes a plurality of laminated dielectric layers 14 and a plurality of inner electrode layers 16 laminated on the dielectric layers 14. The inner electrode layers 16 include first inner electrode layers 16a and second inner electrodes layer 16b. Details of the first inner electrode layers 16a and the second inner electrode layers 16b are described later.

The multilayer body 12 includes a first side surface 12a and a second side surface 12b that face each other in a lamination direction x, a first principal surface 12c and a second principal surface 12d that face each other in a height direction y orthogonal to the lamination direction x, and a first end surface 12e and a second end surface 12f that face each other in a length direction z orthogonal to the lamination direction x and the height direction y. The second principal surface 12d is a surface close to a mounting surface.

The multilayer body 12 includes, inside a single element assembly, a capacitor 18 including a plurality of dielectric layers 14 and a plurality of inner electrode layers 16. Inside the multilayer body 12, a plurality of capacitors 18 are positioned at predetermined intervals in the length direction z and the lamination direction x. In this example embodiment, the capacitors 18 include nine capacitors that are a first capacitor 18₁ to a ninth capacitor 18₉.

The capacitors 18 are preferably provided inside the multilayer body 12 to satisfy a condition of 1≤N≤12 and 2≤M≤12 or 2≤N≤12 and 1≤M≤12, for example, provided that N capacitors 18 are positioned at predetermined intervals in the length direction z and M capacitors 18 are positioned at predetermined intervals in the lamination direction x.

The multilayer body 12 has a rectangular parallelepiped shape. The corner portions and the ridge portions of the multilayer body 12 are preferably rounded. The corner portion is a portion where three surfaces of the multilayer body 12 intersect each other. The ridge portion is a portion where two surfaces of the multilayer body 12 intersect each other. A portion or an entirety of the first side surface 12a and the second side surface 12b, the first principal surface 12c and the second principal surface 12d, and the first end surface 12e and the second end surface 12f may include irregularities etc.

A dimension t of the multilayer body 12 in the height direction y is preferably about 1.00 mm or less, for example.

As illustrated in FIG. 4, the multilayer body 12 includes, in the lamination direction x, the plurality of capacitors 18, a first outer layer portion 20a located between the first side surface 12a and the capacitors 18 (18₁ to 18₃) closest to the first side surface 12a among the plurality of capacitors 18, a second outer layer portion 20b located between the second side surface 12b and the capacitors 18 (18₇ to 18₉) closest to the second side surface 12b among the plurality of capacitors 18, and intermediate layers 21 located between the capacitors 18. The intermediate layer 21 is ten times or more as thick as the dielectric layer 14 of the capacitor 18. In this example embodiment, the intermediate layers 21 include a first intermediate layer 21a located between the capacitors 18₁ to 18₃ and the capacitors 18₄ to 18₆, and a second intermediate layer 21b located between the capacitors 18₄ to 18₆ and the capacitors 18₇ to 18₉.

As illustrated in FIG. 4, the multilayer body 12 includes, in the length direction z, a first end gap 22a located between the capacitors 18 (18₁, 18₄, 18₇) and the first end surface 12e, a second end gap 22b located between the capacitors 18 (18₃, 18₆, 18₉) and the second end surface 12f, and intermediate gaps 23 located between the capacitors 18. In this example embodiment, the intermediate gaps 23 include a first intermediate gap 23a located between the capacitors 18₁, 18₄, 18₇ and the capacitors 18₂, 18₅, 18₈, and a second intermediate gap 23b located between the capacitors 18₂, 18₅, 18₈ and the capacitors 18₃, 18₆, 18₉.

As illustrated in FIG. 5 to FIG. 7, the multilayer body 12 includes, in the height direction y, an upper region 24a located between the capacitors 18 and the first principal surface 12c, and a lower region 24b located between the capacitors 18 and the second principal surface 12d.

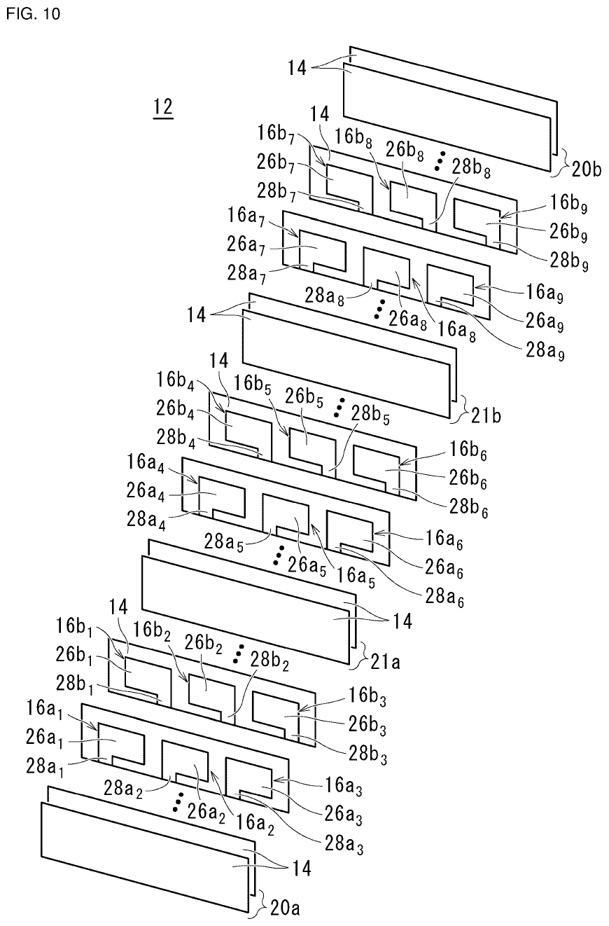

As illustrated in FIG. 4 and FIG. 10, the first outer layer portion 20a is located close to the first side surface 12a of the multilayer body 12, and is an aggregate of a plurality of dielectric layers 14 located between the first side surface 12a and the capacitors 18 (18₁ to 18₃) closest to the first side surface 12a. The second outer layer portion 20b is located close to the second side surface 12b of the multilayer body 12, and is an aggregate of a plurality of dielectric layers 14 located between the second side surface 12b and the capacitors 18 (18₇ to 18₉) closest to the second side surface 12b.

The dielectric layer 14 may be made of a ceramic material such as dielectric ceramics including BaTiO₃, CaTiO₃, SrTiO₃, or CaZrO₃ as a component. A material obtained by adding an auxiliary component such as a Mn compound, an Fe compound, a Cr compound, a Co compound, or a Ni compound to the main component may be used.

The thickness of the dielectric layer 14 is preferably about 0.3 μm or more and about 1.0 μm or less, for example. The number of laminated dielectric layers 14 included in one capacitor 18 is preferably four or more and 1000 or less, for example.

The inner electrode layers 16 include the first inner electrode layers 16a and the second inner electrode layers 16b.

As illustrated in FIG. 4 and FIG. 6, the first inner electrode layers 16a include a plurality of first inner electrode layers 16a₁ to 16a₃ of the first capacitor 18₁ to the third capacitor 18₃, a plurality of first inner electrode layers 16a₄ to 16a₆ of the fourth capacitor 18₄ to the sixth capacitor 18₆, and a plurality of first inner electrode layers 16a₇ to 16a₉ of the seventh capacitor 18₇ to the ninth capacitor 18₉. The first inner electrode layers 16a₁ to 16a₃ are disposed on the same dielectric layer 14. The first inner electrode layers 16a₄ to 16a₆ are disposed on the same dielectric layer 14. The first inner electrode layers 16a₇ to 16a₉ are disposed on the same dielectric layer 14. The first inner electrode layer 16a is extended to the second principal surface 12d.

The first inner electrode layers 16a are described in detail taking the first inner electrode layer 16a₁ as an example. As illustrated in FIG. 6, the first inner electrode layer 16a₁ includes a first counter electrode portion 26a₁ that faces a second inner electrode layer 16b₁, and a first extended portion 28a₁ that runs from the first counter electrode portion 26a₁ and is extended to the second principal surface 12d. The first extended portion 28a₁ includes a first exposed portion 29a₁ exposed on the second principal surface 12d of the multilayer body 12. The shape of the first counter electrode portion 26a₁ and the shape of the first extended portion 28a₁ are not particularly limited, but are each preferably a rectangular shape. The corner portion of the first counter electrode portion 26a₁ may be rounded.

The first inner electrode layers 16a₂ to 16a₉ have the same structure as the first inner electrode layer 16a₁.

As illustrated in FIG. 4 and FIG. 7, the second inner electrode layers 16b include a plurality of second inner electrode layers 16b₁ to 16b₃ of the first capacitor 18₁ to the third capacitor 18₃, a plurality of second inner electrode layers 16b₄ to 16b₆ of the fourth capacitor 18₄ to the sixth capacitor 18₆, and a plurality of second inner electrode layers 16b₇ to 16b₉ of the seventh capacitor 18₇ to the ninth capacitor 18₉. The second inner electrode layers 16b₁ to 16b₃ are disposed on the same dielectric layer 14. The second inner electrode layers 16b₄ to 16b₆ are disposed on the same dielectric layer 14. The second inner electrode layers 16b₇ to 16b₉ are disposed on the same dielectric layer 14. The second inner electrode layer 16b is extended to the second principal surface 12d.

The second inner electrode layers 16b are described in detail taking the second inner electrode layer 16b₁ as an example. As illustrated in FIG. 7, the second inner electrode layer 16b₁ includes a second counter electrode portion 26b₁ that faces the first inner electrode layer 16a₁, and a second extended portion 28b₁ that runs from the second counter electrode portion 26b₁ and is extended to the second principal surface 12d. The second extended portion 28b₁ includes a second exposed portion 29b₁ exposed on the second principal surface 12d of the multilayer body 12. The shape of the second counter electrode portion 26b₁ and the shape of the second extended portion 28b₁ are not particularly limited, but are each preferably a rectangular shape. The corner portion of the second counter electrode portion 26b₁ may be rounded.

The second to ninth inner electrode layers 16b₂ to 16b₉ have the same structure as the second inner electrode layer 16b₁.

In the first capacitor 18₁, the first counter electrode portion 26a₁ of the first inner electrode layer 16a₁ and the second counter electrode portion 26b₁ of the second inner electrode layer 16b₁ face each other. In this example embodiment, the first counter electrode portion 26a₁ of the first inner electrode layer 16a₁ and the second counter electrode portion 26b₁ of the second inner electrode layer 16b₁ face each other via the dielectric layer 14 to produce an electrostatic capacitance and exhibit capacitor characteristics.

The second to ninth capacitors 18₂ to 18₉ have the same structure as the first capacitor 18₁ to exhibit capacitor characteristics.

A Sn layer is included between the dielectric layer 14 and each of the first inner electrode layer 16a and the second inner electrode layer 16b. Therefore, electric field concentration on the interface between the inner electrode layer 16 and the dielectric layer 14 can be reduced, leading to improvement in high-temperature load reliability.

Each of the first inner electrode layer 16a and the second inner electrode layer 16b can be made of any appropriate conductive material such as a metal as typified by Ni, Cu, Ag, Pd, or Au or an alloy including at least one of these metals as typified by an Ag—Pd alloy.

The number of laminated first inner electrode layers 16a of one capacitor 18 is not particularly limited, but is preferably, for example, one or more and 250 or less. The number of laminated second inner electrode layers 16b of one capacitor 18 is not particularly limited, but is preferably, for example, one or more and 250 or less. Thus, the total number of laminated first inner electrode layers 16a and second inner electrode layers 16b of one capacitor 18 is preferably two or more and 500 or less.

The thickness of the first inner electrode layer 16a is not particularly limited, but is preferably, for example, about 0.3 μm or more and about 1.0 μm or less. The thickness of the second inner electrode layer 16b is not particularly limited, but is preferably, for example, about 0.3 μm or more and about 1.0 μm or less.

With the structure of the inner electrode layer 16 that is extended toward the second principal surface 12d (toward the mounting surface), the current path can be shortened, and ESL (Equivalent Series Inductance) can be reduced compared with a general two-terminal capacitor in which inner electrode layers are exposed on both end surfaces.

The plurality of two-terminal capacitors can be replaced with the multi-unit multilayer ceramic capacitor 10 in which the plurality of capacitors are provided in the multilayer body 12.

The outer electrodes 30 include first outer electrodes 30a and second outer electrodes 30b.

The first outer electrodes 30a include a plurality of first outer electrodes 30a₁ to 30a₃. The plurality of first outer electrodes 30a₁ to 30a₃ are provided on the second principal surface 12d at predetermined intervals along the length direction z. The plurality of first outer electrodes 30a₁ to 30a₃ extend in the lamination direction x.

The first outer electrode 30a₁ is electrically connected to the first exposed portions 29a₁, 29a₄, and 29a₇ of the first inner electrode layers 16a₁, 16a₄, and 16a₇. The first outer electrode 30a₁ covers the first exposed portions 29a₁, 29a₄, and 29a₇ of the first inner electrode layers 16a₁, 16a₄, and 16a₇ that are exposed on the second principal surface 12d. The first outer electrode 30a₁ may include first folded portions 31a₁ located also on a portion of the first side surface 12a and a portion of the second side surface 12b.

The first outer electrode 30a₂ is electrically connected to first exposed portions 29a₂, 29a₅, and 29a₈ of the first inner electrode layers 16a₂, 16a₅, and 16a₈. The first outer electrode 30a₂ covers the first exposed portions 29a₂, 29a₅, and 29a₈ of the first inner electrode layers 16a₂, 16a₅, and 16a₈ that are exposed on the second principal surface 12d. The first outer electrode 30a₂ may include first folded portions 31a₂ provided also on a portion of the first side surface 12a and a portion of the second side surface 12b.

The first outer electrode 30a₃ is electrically connected to first exposed portions 29a₃, 29a₆, and 29a₉ of the first inner electrode layers 16a₃, 16a₆, and 16a₉. The first outer electrode 30a₃ covers the first exposed portions 29a₃, 29a₆, and 29a₉ of the first inner electrode layers 16a₃, 16a₆, and 16a₉ that are exposed on the second principal surface 12d. The first outer electrode 30a₃ may include first folded portions 31a₃ provided also on a portion of the first side surface 12a and a portion of the second side surface 12b.

The second outer electrodes 30b include a plurality of second outer electrodes 30b₁ to 30b₃. The plurality of second outer electrodes 30b₁ to 30b₃ are positioned on the second principal surface 12d at predetermined intervals along the length direction z. The plurality of second outer electrodes 30b₁ to 30b₃ extend in the lamination direction x.

The second outer electrode 30b₁ is electrically connected to the second exposed portions 29b₁, 29b₄, and 29b₇ of the second inner electrode layers 16b₁, 16b₄, and 16b₇. The second outer electrode 30b₁ covers the second exposed portions 29b₁, 29b₄, and 29b₇ of the second inner electrode layers 16b₁, 16b₄, and 16b₇ that are exposed on the second principal surface 12d. The second outer electrode 30b₁ may include second folded portions 31b₁ provided also on a portion of the first side surface 12a and a portion of the second side surface 12b.

The second outer electrode 30b₂ is electrically connected to second exposed portions 29b₂, 29b₅, and 29b₈ of the second inner electrode layers 16b₂, 16b₅, and 16b₈. The second outer electrode 30b₂ covers the second exposed portions 29b₂, 29b₅, and 29b₈ of the second inner electrode layers 16b₂, 16b₅, and 16b₈ that are exposed on the second principal surface 12d. The second outer electrode 30b₂ may include second folded portions 31b₂ provided also on a portion of the first side surface 12a and a portion of the second side surface 12b.

The second outer electrode 30b₃ is electrically connected to second exposed portions 29b₃, 29b₆, and 29b₉ of the second inner electrode layers 16b₃, 16b₆, and 16b₉. The second outer electrode 30b₃ covers the second exposed portions 29b₃, 29b₆, and 29b₉ of the second inner electrode layers 16b₃, 16b₆, and 16b₉ that are exposed on the second principal surface 12d. The second outer electrode 30b₃ may include second folded portions 31b₃ provided also on a portion of the first side surface 12a and a portion of the second side surface 12b.

The ratio of the maximum length to the minimum length about a length l₁ in the length direction z for the first outer electrode 30a located on the second principal surface 12d is preferably about 1.0 or more and about 1.5 or less, for example.

The ratio of the maximum length to the minimum length about a length l₂ in the length direction z for the second outer electrode 30b located on the second principal surface 12d is preferably about 1.0 or more and about 1.5 or less, for example.

With the above structure, the occurrence of electrochemical migration between the outer electrodes 30 can be reduced or prevented.

With the above structure, the mountability of the multi-unit multilayer ceramic capacitor 10 on a mounting board can be improved. Specifically, the improvement in mountability refers to, for example, improvement against misalignment or shifting and stabilization of the mounting posture of the multi-unit multilayer ceramic capacitor 10 at the time of mounting.

A distance l₀ in the length direction z between the first outer electrode 30a and the second outer electrode 30b is preferably about 10 μm or more, for example. With the above structure, the occurrence of electrochemical migration between the outer electrodes 30 can further be reduced or prevented.

A difference between the maximum thickness and the minimum thickness about a thickness tₑ of each of the first outer electrode 30a and the second outer electrode 30b in the height direction y is preferably about 30 μm or less, for example.

With the above structure, the mountability of the multi-unit multilayer ceramic capacitor 10 on the mounting board can further be improved.

A length h of each of the first folded portions 31a₁ to 31a₃ and the second folded portions 31b₁ to 31b₃ in the height direction y is preferably about ½ or less of the dimension t of the multilayer body 12 in the height direction y, for example.

With the structure in which each outer electrode 30 has the folded portions disposed on both the side surfaces, the mountability of the multi-unit multilayer ceramic capacitor 10 can further be stabilized. When the length h of each of the first folded portions 31a₁ to 31a₃ and the second folded portions 31b₁ to 31b₃ in the height direction y is about ½ or less of the dimension t of the multilayer body 12 in the height direction y, for example, solder wetting can be reduced or prevented and the mountability is further improved.

Description is made about an example in which the minimum length and the maximum length greatly differ from each other about each of the lengths l₁ and l₂ in the length direction z for the first outer electrode 30a and the second outer electrode 30b located on the second principal surface 12d.

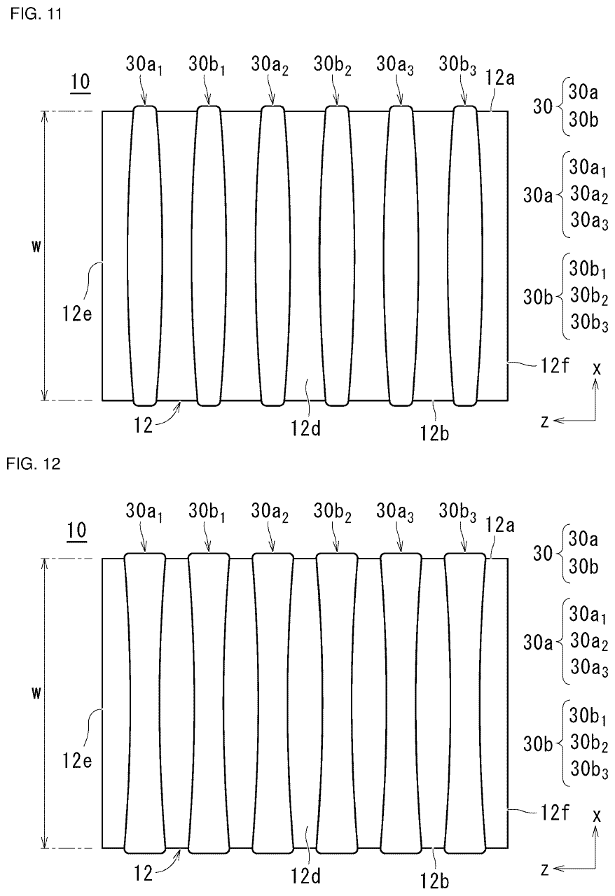

As illustrated in FIG. 11, the length l₁ may be the maximum length near w/2 on each of the first outer electrodes 30a₁ to a₃, and may be the minimum length near both the side surfaces 12a and 12b.

Similarly, the length l₂ may be the maximum length near w/2 on each of the second outer electrodes 30b₁ to b₃, and may be the minimum length near both the side surfaces 12a and 12b.

As illustrated in FIG. 12, the length l₁ may be the minimum length near w/2 on each of the first outer electrodes 30a₁ to a₃, and may be the maximum length near both the side surfaces 12a and 12b.

Similarly, the length l₂ may be the minimum length near w/2 on each of the second outer electrodes 30b₁ to b₃, and may be the maximum length near both the side surfaces 12a and 12b.

The outer electrodes 30 include underlying electrode layers 32 on the surface of the multilayer body 12, and plating layers 34 covering the underlying electrode layers 32.

The underlying electrode layers 32 include first underlying electrode layers 32a and second underlying electrode layers 32b.

The plating layers 34 include first plating layers 34a and second plating layers 34b.

In other words, the first outer electrodes 30a include the first underlying electrode layers 32a and the first plating layers 34a. More specifically, the first outer electrodes 30a₁ to 30a₃ include first underlying electrode layers 32a₁ to 32a₃ and first plating layers 34a₁ to 34a₃.

The second outer electrodes 30b include the second underlying electrode layers 32b and the second plating layers 34b. More specifically, the second outer electrodes 30b₁ to 30b₃ include second underlying electrode layers 32b₁ to 32b₃ and second plating layers 34b₁ to 34b₃.

The first underlying electrode layers 32a₁ to 32a₃ are located on the second principal surface 12d of the multilayer body 12 and extend from the second principal surface 12d and cover a portion of the first side surface 12a and a portion of the second side surface 12b.

The second underlying electrode layers 32b₁ to 32b₃ are located on the second principal surface 12d of the multilayer body 12 and extend from the second principal surface 12d and cover a portion of the first side surface 12a and a portion of the second side surface 12b.

The underlying electrode layer 32 includes at least one selected from among a baked layer, a conductive resin layer, or a thin film layer, etc.

Description is now made about each structure in the case where the underlying electrode layer 32 is the baked layer, the conductive resin layer, or the thin film layer described above.

The baked layer includes a glass component and a metal component. The glass component of the baked layer includes at least one selected from among B, Si, Ba, Mg, Al, or Li, etc. The metal component of the baked layer includes at least one selected from among, for example, Cu, Ni, Ag, Pd, Ag—Pd alloy, or Au. The baked layer may be a plurality of layers. The baked layer is obtained by applying a conductive paste including the glass component and the metal component to the multilayer body 12 and baking the conductive paste. The baked layer may be obtained by simultaneously baking a multilayer chip including the inner electrode layers 16 and the dielectric layers 14 and a conductive paste applied to the multilayer chip, or may be obtained by baking a multilayer chip including the inner electrode layers 16 and the dielectric layers 14 to obtain the multilayer body 12, applying a conductive paste to the multilayer body 12, and baking the conductive paste. When the baked layer is obtained by simultaneously baking a multilayer chip including the inner electrode layers 16 and the dielectric layers 14 and a conductive paste applied to the multilayer chip, the baked layer is preferably formed by baking a material including a dielectric material added instead of the glass component.

In each of the first underlying electrode layers 32a₁ to 32a₃ located on the second principal surface 12d, the thickness in the height direction y connecting the first principal surface 12c and the second principal surface 12d is preferably about 10 μm or more and about 30 μm or less, for example.

In each of the second underlying electrode layers 32b₁ to 32b₃ located on the second principal surface 12d, the thickness in the height direction y connecting the first principal surface 12c and the second principal surface 12d is preferably about 10 μm or more and about 30 μm or less, for example.

In each of the first folded portions 31a₁ to 31a₃ of the first underlying electrode layers 32a₁ to 32a₃ located on a portion of the first side surface 12a and a portion of the second side surface 12b, the thickness in the lamination direction x connecting the first side surface 12a and the second side surface 12b at a central portion in the height direction y connecting the first principal surface 12c and the second principal surface 12d is preferably, for example, about 1 μm or more and about 20 μm or less.

In each of the second folded portions 31b₁ to 31b₃ of the second underlying electrode layers 32b₁ to 32b₃ located on a portion of the first side surface 12a and a portion of the second side surface 12b, the thickness in the lamination direction x connecting the first side surface 12a and the second side surface 12b at a central portion in the height direction y connecting the first principal surface 12c and the second principal surface 12d is preferably, for example, about 1 μm or more and about 20 μm or less.

The conductive resin layer may be disposed on a baked layer to cover the baked layer, or disposed directly on the multilayer body 12 without the baked layer. The conductive resin layer may completely cover the baked layer, or cover a portion of the baked layer. The conductive resin layer may be a plurality of layers.

The conductive resin layer includes a thermosetting resin and a metal. Since the conductive resin layer includes the thermosetting resin, the conductive resin layer has higher flexibility than, for example, a plating layer or a baked layer that is a baked product of a conductive paste. Therefore, when the multi-unit multilayer ceramic capacitor 10 receives a physical impact or an impact caused by a heat cycle, the conductive resin layer functions as a cushioning layer, and cracking of the multi-unit multilayer ceramic capacitor 10 can be prevented.

The metal included in the conductive resin layer may be Ag, Cu, Ni, Sn, Bi, or an alloy including any of these metals. A metal powder coated with Ag on its surface may be used. When the metal powder coated with Ag on its surface is used, the metal powder is preferably a powder of Cu, Ni, Sn, Bi, or an alloy thereof. The reasons why the conductive metal powder of Ag is used as the conductive metal are as follows. Ag is suitable as the electrode material because the specific resistance is lowest among the metals. Ag is not oxidized and weather resistance is high because Ag is the noble metal. An inexpensive base metal can be used while maintaining the above Ag characteristics.

The metal included in the conductive resin layer may be Cu or Ni subjected to antioxidation treatment. The metal included in the conductive resin layer may be a metal powder coated with Sn, Ni, or Cu on its surface. When the metal powder coated with Sn, Ni, or Cu on its surface is used, the metal powder is preferably a powder of Ag, Cu, Ni, Sn, Bi, or an alloy thereof.

The metal included in the conductive resin layer mainly provides conductivity to the conductive resin layer. Specifically, a conductive path is formed in the conductive resin layer by contact between conductive fillers.

The metal included in the conductive resin layer may include a spherical shape, a flat shape, etc., but is preferably a mixture of a spherical metal powder and a flat metal powder.

The resin in the conductive resin layer may be various known thermosetting resins such as an epoxy resin, a phenol resin, a urethane resin, a silicone resin, and a polyimide resin. Among others, the epoxy resin excellent in heat resistance, moisture resistance, adhesion, etc. is one of the most appropriate resins.

The conductive resin layer preferably includes a thermosetting resin and a curing agent. When the epoxy resin is used as the base resin, the curing agent for the epoxy resin may be various known compounds such as phenol-based, amine-based, acid anhydride-based, imidazole-based, activated ester-based, and amide-imide-based compounds.

The thickest portion of the conductive resin layer is preferably, for example, about 3 μm or more and about 20 μm or less.

When the thin film layer is provided as the underlying electrode layer 32, the thin film layer is a layer of about 1 μm or less, for example, with metal particles deposited by a thin film forming method such as sputtering or vapor deposition.

The plating layers 34 cover the underlying electrode layers 32. The plating layers 34 include the first plating layers 34a and the second plating layers 34b.

The first plating layers 34a cover the first underlying electrode layers 32a. More specifically, the first plating layers 34a₁ to 34a₃ cover the first underlying electrode layers 32a₁ to 32a3.

The second plating layers 34b cover the second underlying electrode layers 32b. More specifically, the second plating layers 34b₁ to 34b₃ cover the second underlying electrode layers 32b₁ to 32b₃.

Each of the first plating layer 34a and the second plating layer 34b includes at least one selected from among, for example, Cu, Ni, Sn, Ag, Pd, Ag—Pd alloy, or Au.

The plating layer 34 may be a plurality of layers. In this case, the plating layer 34 preferably has a two-layer structure including a lower plating layer formed on the underlying electrode layer 32 and plated with Ni, and an upper plating layer formed on the lower plating layer and plated with Sn.

That is, the first plating layer 34a includes a first lower plating layer and a first upper plating layer located on the surface of the first lower plating layer.

The second plating layer 34b includes a second lower plating layer and a second upper plating layer located on the surface of the second lower plating layer.

The lower plating layer plated with Ni is used for preventing the underlying electrode layer 32 from being corroded by solder when the multi-unit multilayer ceramic capacitor 10 is mounted. The upper plating layer plated with Sn is used to easily mount the multi-unit multilayer ceramic capacitor 10 by improving the wettability of solder for mounting.

The thickness of one plating layer is preferably about 1 μm or more and about 10 μm or less, for example.

The dimension of the multi-unit multilayer ceramic capacitor 10 in the length direction z is a dimension L. The dimension L is preferably about 0.8 mm or more and about 14.4 mm or less, for example. The dimension L may be about 0.2 mm or more and about 20.0 mm or less, for example.

The dimension of the multi-unit multilayer ceramic capacitor 10 in the height direction y is a dimension T. The dimension T is preferably about 0.5 mm or more and about 0.8 mm or less, for example. The dimension T may be about 0.2 mm or more and about 1.0 mm or less, for example.

The dimension of the multi-unit multilayer ceramic capacitor 10 in the lamination direction x is a dimension W. The dimension W is preferably about 0.4 mm or more and about 7.8 mm or less, for example. The dimension W may be about 0.2 mm or more and about 20.0 mm or less, for example.

In the multi-unit multilayer ceramic capacitor 10 illustrated in FIG. 1, the inner electrode layer 16 is exposed only on the second principal surface 12d that is the surface close to the mounting surface. Thus, the current path can be shortened, and therefore ESL (Equivalent Series Inductance) can be reduced compared with a general two-terminal capacitor in which inner electrode layers are exposed on both end surfaces.

In the multi-unit multilayer ceramic capacitor 10 illustrated in FIG. 1, the multilayer body 12 includes, inside the single element assembly, the capacitor 18 including the plurality of dielectric layers 14 and the plurality of inner electrode layers 16. Inside the multilayer body 12, the plurality of capacitors 18 are positioned at predetermined intervals in the length direction z and the lamination direction x. Thus, the plurality of two-terminal capacitors can be replaced only with the multi-unit multilayer ceramic capacitor 10.

In the multi-unit multilayer ceramic capacitor 10 illustrated in FIG. 1, the number of capacitors 18 provided inside the multilayer body 12 of the multi-unit multilayer ceramic capacitor 10 is adjusted depending on disposition of land electrodes. Therefore, the disposition of the land electrodes for the general two-terminal capacitors can be used as it is without changing design.

Next, a non-limiting example of a method for manufacturing the multi-unit multilayer ceramic capacitor is described. A non-limiting example of a method for manufacturing the multi-unit multilayer ceramic capacitor 10 is described below.

First, dielectric sheets for dielectric layers and conductive pastes for inner electrodes are prepared. The dielectric sheets and the conductive pastes for inner electrodes contain binders and solvents. Known binders and solvents may be used.

Next, the conductive pastes for inner electrodes are printed on the dielectric sheets in predetermined patterns by, for example, screen printing or gravure printing. Thus, dielectric sheets with the pattern of the first inner electrode layers and dielectric sheets with the pattern of the second inner electrode layers are prepared.

A portion defining and functioning as the plurality of capacitors is formed by alternately laminating the dielectric sheets printed with the first inner electrode layers and the dielectric sheets printed with the second inner electrode layers to obtain a desired structure.

Next, a portion serving as the first outer layer portion 20a close to the first side surface 12a is formed by laminating a predetermined number of dielectric sheets not printed with the patterns of the inner electrode layers. Then, the portion serving as the plurality of capacitors 18 formed in the above step is laminated on the portion serving as the first outer layer portion 20a. Next, the intermediate layer 21 is formed by laminating a predetermined number of dielectric sheets not printed with the patterns of the inner electrode layers on the portion serving as the plurality of capacitors 18. Then, a portion serving as a plurality of other capacitors 18 formed in the above step is laminated on the intermediate layer 21. The layer including the capacitors 18 and the intermediate layer 21 are repeatedly formed a predetermined number of times. Lastly, the second outer layer portion 20b close to the second side surface 12b is formed by laminating a predetermined number of dielectric sheets not printed with the patterns of the inner electrode layers on the portion serving as the plurality of capacitors 18. Thus, a multilayer sheet is produced.

Next, a multilayer block of the multi-unit multilayer ceramic capacitor is produced by pressing the multilayer sheet in the lamination direction via isostatic press, etc.

Next, the multilayer block is cut to a predetermined size, and therefore a multilayer chip is cut out. At this time, the corner portions and the ridge portions of the multilayer chip may be rounded by barrel finishing etc.

The multilayer body 12 is produced by baking the multilayer chip thus cut out. The baking temperature is preferably about 900° C. or more and about 1400° C. or less, for example, depending on the materials of the dielectric layers 14 and the inner electrode layers 16.

Next, the first underlying electrode layers 32a of the plurality of first outer electrodes 30a and the second underlying electrode layers 32b of the plurality of second outer electrodes 30b are formed on the second principal surface 12d of the multilayer body 12 obtained by baking.

When a baked layer is formed as the underlying electrode layer 32, a conductive paste including a glass component and a metal component is applied and then baked. Thus, the baked layer is formed as the underlying electrode layer 32. At this time, the baking temperature is preferably about 700° C. or more and about 900° C. or less, for example. In this example embodiment, the underlying electrode layer 32 is the baked layer.

Various methods may be used as the method for forming the baked layer. For example, there may be used a method in which the direction of the multilayer body 12 is adjusted using a camera or magnet such that the second principal surface 12d is oriented downward, the multilayer body 12 is then held by a holding jig, and the conductive paste is applied by being ejected from a slit or hole. In the case of this method, the underlying electrode layer 32 can be formed not only on the second principal surface 12d but also up to a portion of the first side surface 12a and a portion of the second side surface 12b by increasing the ejection amount of the conductive paste.

A roller transfer method may be used for formation. When the underlying electrode layer 32 is formed not only on the second principal surface 12d but also up to a portion of the first side surface 12a and a portion of the second side surface 12b by the roller transfer method, the underlying electrode layer 32 can be formed up to a portion of the first side surface 12a and a portion of the second side surface 12b by increasing the pushing pressure during the roller transfer.

When a conductive resin layer is formed as the underlying electrode layer 32, the conductive resin layer can be formed by the following method. The conductive resin layer may be formed on the surface of a baked layer, or the conductive resin layer alone may be formed directly on the multilayer body 12 without the baked layer.

As the method for forming the conductive resin layer, a conductive resin paste including a thermosetting resin and a metal component is applied to the baked layer or the multilayer body 12, and the resin is thermally cured by heat treatment at a temperature of about 250° C. or more and about 550° C. or less, for example. Thus, the conductive resin layer is formed. At this time, the atmosphere during the heat treatment is preferably a N₂ atmosphere. To prevent scattering of the resin and prevent oxidation of various metal components, the oxygen concentration is preferably about 100 ppm or less, for example.

The method for applying the conductive resin paste may be, for example, a method in which the conductive resin paste is applied by being ejected from a slit, as in the method for forming the baked layer as the underlying electrode layer 32.

When a thin film layer is formed as the underlying electrode layer 32, the underlying electrode layer 32 can be formed by carrying out masking, etc., and a thin film forming method such as sputtering or vapor deposition at the location where the outer electrode 30 is to be formed. The underlying electrode layer 32 formed from the thin film layer is a layer of about 1 μm or less with metal particles deposited, for example.

Lastly, the plating layers 34 are formed. The plating layers 34 are formed on the surfaces of the underlying electrode layers 32. More specifically, a nickel plating layer serving as a lower plating layer and a tin plating layer serving as an upper plating layer are formed on the underlying electrode layer 32. The plating may be either electrolytic plating or non-electrolytic plating. However, the non-electrolytic plating is disadvantageous in that pretreatment using a catalyst, etc., is required to improve the plating precipitation rate, thereby complicating the steps. Thus, the electrolytic plating is preferably used in general.

In the manner described above, the multi-unit multilayer ceramic capacitor 10 according to this example embodiment is manufactured.

To check the effects of multi-unit multilayer ceramic capacitors according to example embodiments of the present invention, experiments for checking the influence of electrochemical migration and the mountability was conducted by producing samples changed in dimensions of the outer electrodes (the distance between the outer electrodes, the difference in thickness of the outer electrode, and the width of the outer electrode) and samples changed in dimensions of the folded portions of the outer electrodes as experimental samples based on the above manufacturing method.

Multi-unit multilayer ceramic capacitors were produced using the manufacturing method according to the example embodiment.
Number of capacitors included in multi-unit multilayer ceramic capacitor (N×M): 2×2
Dimension of multi-unit multilayer ceramic capacitor in length direction: 2.25 mm
Dimension of multi-unit multilayer ceramic capacitor in lamination direction: 1.25 mm
Dimension of multi-unit multilayer ceramic capacitor in height direction: 0.45 mm
Thickness of dielectric layer: 0.50 μm
Thickness of inner electrode layer: 0.50 μm
Number of laminated layers: 400

Whether electrochemical migration occurred was checked on each sample after a moisture resistance load test. For the check, a digital microscope manufactured by Keyence Corporation (VHX-5000, VHX-8000) was used.

The moisture resistance load test was checked as follows.

That is, the moisture resistance load test was conducted such that 4 V or less was kept for 144 hours at a temperature of 125° C. and a relative humidity of 95% R.H.

A warm bath manufactured by ESPEC Corporation (EHS-221M, EHS-222M) was used as the test bath. The number of products was 100 for each sample. When electrochemical migration occurred in any one of the 100 products, determination was made as “unsatisfactory.”

The prepared samples of Sample Number 1 to Sample Number 5 were 5 μm, 10 μm, 60 μm, 150 μm, and 200 μm in terms of the distance between the outer electrodes.

In each sample, the thickness of the outer electrode was fixed to 20 μm.

In each sample, the wetting of the folded portion was adjusted so as not to reach the first principal surface.

Table 1 shows results of the check on the presence or absence of electrochemical migration in relation to changes in distance l₀ between the outer electrodes.

TABLE 1

| Sample | Distance l₀ between | Presence or absence of |
|---|---|---|
| number | outer electrodes (μm) | electrochemical migration |
| 1 | 5 | x |
| 2 | 10 | ∘ |
| 3 | 60 | ∘ |
| 4 | 150 | ∘ |
| 5 | 200 | ∘ |

According to Table 1, in the sample of Sample Number 1, when the distance l₀ between the outer electrodes was 5 μm, electrochemical migration occurred in the sample multi-unit multilayer ceramic capacitor.

In the samples of Sample Number 2 to Sample Number 5, the distance l₀ between the outer electrodes was 10 μm or more. Therefore, the occurrence of electrochemical migration was not observed in the sample multi-unit multilayer ceramic capacitor.

Each sample was mounted on a board and the mounting state was checked based on the following test conditions. For the check, a digital microscope manufactured by Keyence Corporation (VHX-8000) was used.

Tombstone: state in which the outer electrode and solder on a board land are not in contact with each other

Misalignment, shifting: state of projection by ½ or more of the solder printing dimension beyond the board land, or state in which the rotation angle of the sample is more than 5°
Solder type: M705-GRN360-K2-V
Mask thickness: 100 μm
Board thickness: 1.6 mm
Reflow conditions: preheating: kept for 90 seconds within range of 150° C. or more and 180° C. or less
: main heating: kept within range of 30 seconds to 60 seconds at 220° C. or more
: peak temperature: 235° C. or more and 240° C. or less
: air atmosphere was made
: number of reflow operations was one

The number of products was 100 for each sample.

The prepared samples of Sample Number 6 to Sample Number 9 were 15 μm, 30 μm, 40 μm, and 60 μm in terms of the difference in thickness of the outer electrode.

In each sample, the distance between the outer electrodes was fixed to 100 μm.

In each sample, the wetting of the folded portion was adjusted so as not to reach the first principal surface.

The prepared samples of Sample Number 10 to Sample Number 13 were 1.0, 1.5, 1.7, and 1.9 in terms of the ratio of the maximum length to the minimum length about each of the lengths l₁ and l₂ of the outer electrodes in the length direction z.

In each sample, the distance between the outer electrodes was fixed to 100 μm.

In each sample, the wetting of the folded portion was adjusted so as not to reach the first principal surface.

Table 2 shows results of determination on the mountability of the multi-unit multilayer ceramic capacitor in relation to changes in difference in thickness of the outer electrode. Table 3 shows results of determination on the mountability in relation to changes in ratio of the maximum length to the minimum length about each of the lengths l₁ and l₂ of the outer electrodes in the length direction z.

TABLE 2

| | Difference in | | Presence or |
|---|---|---|---|
| Sample | thickness of outer | | absence of |
| number | electrode (μm) | Self-alignment | tombstone |
| 6 | 15 | ∘ | ∘ |
| 7 | 30 | ∘ | ∘ |
| 8 | 40 | x | x |
| 9 | 60 | x | x |

TABLE 3

| | Ratio of maximum | | |
|---|---|---|---|
| | length to minimum | | |
| | length about length | | Presence or |
| Sample | of outer electrode | | absence of |
| number | in length direction | Self-alignment | tombstone |
| 10 | 1.0 | ∘ | ∘ |
| 11 | 1.5 | ∘ | ∘ |
| 12 | 1.7 | x | x |
| 13 | 1.9 | x | x |

According to Table 2, in the samples of Sample Number 6 and Sample Number 7, the difference in thickness of the outer electrode was about 15 μm and about 30 μm, for example. Therefore, it was observed, as the mountability, that the self-alignment was satisfactory and the occurrence of tombstone was reduced or prevented.

In the samples of Sample Number 8 and Sample Number 9, when the difference in thickness of the outer electrode was relatively larger, namely about 40 μm and about 60 μm, for example, it was observed, as the mountability, that the self-alignment was unsatisfactory and tombstone occurred.

According to Table 3, in the samples of Sample Number 10 and Sample Number 11, the ratio of the maximum length to the minimum length about each of the lengths l₁ and l₂ of the outer electrodes in the length direction z was about 1.0 and about 1.5, for example. Therefore, it was observed, as the mountability, that the self-alignment was satisfactory and the occurrence of tombstone was reduced or prevented.

In the samples of Sample Number 12 and Sample Number 13, when the ratio of the maximum length to the minimum length about each of the lengths l₁ and l₂ of the outer electrodes in the length direction z was about 1.7 and about 1.9, for example, it was observed, as the mountability, that the self-alignment was unsatisfactory and tombstone occurred.

Samples in which the folded portion reached the first principal surface and samples in which the size of the folded portion was about ½ or less of the size of the multilayer body in the height direction were prepared.

Each sample was mounted on a board and the mounting state was checked. For the check, a digital microscope manufactured by Keyence Corporation (VHX-8000) was used.

Tombstone: state in which the outer electrode and solder on a board land are not in contact with each other

Misalignment, shifting: state of projection by about ½ or more of the solder printing dimension beyond the board land, or state in which the rotation angle of the sample is more than about 50.
Solder type: M705-GRN360-K2-V
Mask thickness: 100 μm
Board thickness: 1.6 mm
Reflow conditions: preheating: kept for 90 seconds within range of 150° C. or more and 180° C. or less
: main heating: kept within range of 30 seconds to 60 seconds at 220° C. or more
: peak temperature: 235° C. or more and 240° C. or less
: air atmosphere was made
: number of reflow operations was one

The number of products was 100 for each sample.

In Sample Number 14, the wetting of the folded portion was adjusted so as not to reach the first principal surface. In Sample Number 15, the wetting of the folded portion reached the first principal surface.

In each sample, the difference in thickness of the outer electrode was fixed to 20 μm.

In each sample, the distance between the outer electrodes was fixed to 100 μm.

Table 4 shows results of determination on the mountability in relation to changes in length h of the folded portion in the height direction y and dimension t of the multilayer body in the height direction y.

TABLE 4

| Sample | | | Presence or |
|---|---|---|---|
| number | Dimension of wetting | Self-alignment | absence of tombstone |
| 14 | ½ or less in | ∘ | ∘ |
| | height direction | | |
| 15 | Reach first | x | x |
| | principal surface | | |

According to Table 4, in the sample of Sample Number 14, the size of the folded portion of the outer electrode was about ½ or less of the size of the multilayer body in the height direction y. Therefore, it was observed, as the mountability, that the self-alignment was satisfactory and the occurrence of tombstone was reduced or prevented.

In the sample of Sample Number 15, when the folded portion reached the first principal surface, it was observed, as the mountability, that the self-alignment was unsatisfactory and tombstone occurred.

From the results of the above experiment, the following effects were observed.

When the distance l₀ between the outer electrodes was about 10 μm or more, it was observed that the occurrence of electrochemical migration between the outer electrodes was reduced or prevented.

When the difference in thickness of the outer electrodes was about 15 μm and about 30 μm, for example, it was observed that the mountability was improved, that is, improvement was achieved against misalignment or shifting and the chip posture was stable at the time of mounting. When the ratio of the maximum length to the minimum length about each of the lengths l₁ and l₂ of the outer electrodes in the length direction z was about 1.0 and about 1.5, for example, it was observed that the mountability was improved, that is, improvement was achieved against misalignment or shifting and the chip posture was stable at the time of mounting.

When the size of the folded portion of the outer electrode was about ½ or less, for example, of the size of the multilayer body in the height direction, it was observed that the mountability was improved by reduction or prevention of the solder wetting.

Although example embodiments of the present invention are disclosed in the above description, the present invention is not limited thereto.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multi-unit multilayer ceramic capacitor comprising:
a multilayer body including a first side surface and a second side surface that face each other in a lamination direction, a first principal surface and a second principal surface that face each other in a height direction orthogonal to the lamination direction, and a first end surface and a second end surface that face each other in a length direction orthogonal to both the lamination direction and the height direction;
a first outer electrode extending in the lamination direction on the second principal surface; and
a second outer electrode extending in the lamination direction on the second principal surface; wherein
the multilayer body includes, inside a single element assembly, a plurality of capacitors each including a plurality of dielectric layers and a plurality of inner electrode layers, the plurality of capacitors being positioned at predetermined intervals in the length direction and the lamination direction;
the inner electrode layers include:
first inner electrode layers connected to the first outer electrode; and
second inner electrode layers connected to the second outer electrode;
each of the first inner electrode layers includes:
a first counter electrode portion; and
a first extended portion protruding toward the first outer electrode; and
each of the second inner electrode layers includes:
a second counter electrode portion; and
a second extended portion protruding toward the second outer electrode.

2. The multi-unit multilayer ceramic capacitor according to claim 1, wherein a ratio between a maximum width and a minimum width of each of the first and second outer electrodes in the length direction is about 1.0 or more and about 1.5 or less.

3. The multi-unit multilayer ceramic capacitor according to claim 2, wherein a difference in thickness of each of the first and second outer electrodes in the height direction is about 30 μm or less.

4. The multi-unit multilayer ceramic capacitor according to claim 3, wherein a distance between the first outer electrode and the second outer electrode in the length direction is about 10 μm or more.

5. The multi-unit multilayer ceramic capacitor according to claim 4, wherein
the first outer electrode includes a first folded portion extending from the second principal surface to a portion of each of the first and second side surfaces;
the second outer electrode includes a second folded portion extending from the second principal surface to a portion of each of the first and second side surfaces; and
a size of each of the first and second folded portions in the height direction is about ½ or less of a size of the multilayer body in the height direction.

6. The multi-unit multilayer ceramic capacitor according to claim 5, wherein
the multilayer body includes the plurality of capacitors such that N capacitors are positioned at the predetermined intervals in the length direction and M capacitors are positioned at the predetermined intervals in the lamination direction; and
one of the following conditions is satisfied:
$$1 \leq N \leq 12 and 2 \leq M \leq 12 ; \\ or \\ 2 \leq N \leq 12 and 1 \leq M \leq 12 .$$

7. The multi-unit multilayer ceramic capacitor according to claim 6, wherein a dimension of the multilayer body in the height direction is about 1.00 mm or less.

8. The multi-unit multilayer ceramic capacitor according to claim 1, wherein a total number of the plurality of capacitors is nine.

9. The multi-unit multilayer ceramic capacitor according to claim 1, further comprising intermediate layers between the plurality of capacitors.

10. The multi-unit multilayer ceramic capacitor according to claim 1, further comprising a Sn layer between one of the dielectric layers and a pair of the first and second inner electrode layers.

11. The multi-unit multilayer ceramic capacitor according to claim 1, wherein
a thickness of the first inner electrode layers is about 0.3 μm or more and about 1.0 μm or less; and
a thickness of the second inner electrode layers is about 0.3 μm or more and about 1.0 μm or less.

12. The multi-unit multilayer ceramic capacitor according to claim 1, wherein
the first outer electrode is electrically connected to and covers exposed portions of the first inner electrode layers;
the second outer electrode is electrically connected to and covers exposed portions of the second inner electrode layers.

13. The multi-unit multilayer ceramic capacitor according to claim 1, wherein each of the first outer electrode and the second outer electrode includes an underlying electrode layer and a plating layer.

14. The multi-unit multilayer ceramic capacitor according to claim 13, wherein the underlying electrode layer includes first and second underlying electrode layers, and the plating layer includes first and second plating layers.

15. The multi-unit multilayer ceramic capacitor according to claim 13, wherein the underlying electrode layer is one of a baked layer, a conductive resin layer or a thin film layer.

16. The multi-unit multilayer ceramic capacitor according to claim 13, wherein the plating layer includes a Ni plating layer and a Sn plating layer.

17. The multi-unit multilayer ceramic capacitor according to claim 1, wherein the multi-unit multilayer ceramic capacitor has a dimension in the length direction of about 0.8 mm or more and about 14.4 mm or less, a dimension in the height direction of about 0.5 mm or more and about 0.8 mm or less, and a dimension in the lamination direction of about 0.4 mm or more and about 7.8 mm or less.

18. The multi-unit multilayer ceramic capacitor according to claim 1, wherein the multi-unit multilayer ceramic capacitor has a dimension in the length direction of about 0.2 mm or more and about 20.0 mm or less, a dimension in the height direction of about 0.2 mm or more and about 1.0 mm or less, and a dimension in the lamination direction of about 0.2 mm or more and about 20.0 mm or less.

19. The multi-unit multilayer ceramic capacitor according to claim 1, wherein one of the inner electrode layers is exposed only on the second principal surface that is closest to a mounting surface.

20. The multi-unit multilayer ceramic capacitor according to claim 2, wherein a difference in thickness of each of the first and second outer electrodes in the height direction is about 15 μm or less.
